(19) United States
(12) Patent Application Publication
(10) Pub. No.: US 2002/0079323 A1
(43) Pub. Date: Jun. 27, 2002

(54) Vending machine having a rotatable vending rack

(75) Inventor: Thomas Robert Lauer, Cleveland, OH (US)

Correspondence Address: Marvin L. Union, 13530 Heath Road, Novelty, OH, 44072, US

(73) Assignee: Vendcraft, Inc., Novelty, OH (US)

(21) Appl. No.: 09/748,498

(22) Filed: Dec. 26, 2000

(51) Int. Cl. G07F 11/62

(52) U.S. Cl. 221/119; 221/9

(57) ABSTRACT

A machine for dispensing containers such as bottles and cans which are supported in an upright position includes a vending rack in which the can or bottles are supported. The vending rack is rotatable about a vertical axis at least 180° to enable the back of the vending rack to be rotated to a position in which the back of the vending rack is located adjacent the front of the machine to facilitate loading of containers to be vended in the vending rack. The containers can be vended in a first in first out fashion.

### BACKGROUND OF THE INVENTION

### RELATED APPLICATIONS

U.S. Pat. No. 6,112,943 entitled Vending Machine for Bottles and assigned to the same Assignee as the present invention is incorporated herein by reference.

### DESCRIPTION—TECHNICAL FIELD

The present invention relates to machines for vending and/or dispensing bottles and/or containers and more particularly to a simple, low cost machine for dispensing or vending bottles and/or containers such as cans sequentially which are supported in an upright position. The vending machine includes a storage cabinet having a rotatable vending rack therein which has a plurality of planar dispensing racks supported thereby. Each of the planar dispensing racks includes a plurality of elongated slots for storing and dispensing bottles and/or containers from the dispensing rack. The vending rack is rotatable about a vertical axis at least 180° to enable the vending rack to be rotated to a position in which the back of vending rack is located at the front of the storage cabinet to facilitate loading of the plurality of dispensing racks with bottles and/or containers to be vended. When the vending rack is rotated 180° to a position in which the back of the dispensing rack is located at the front of the storage cabinet bottles and/or containers may be loaded into the back of the dispensing rack so that merchandise in the dispensing rack is dispensed in a first in first out fashion when the vending rack is rotated 180° to its dispensing position in which the front of the vending rack is located adjacent the front of the storage cabinet. Gate members may be provided for controlling the movement of bottles and/or containers from the dispensing racks.

### BACKGROUND OF THE INVENTION

Machines are well known for vending or dispensing articles such as bottled and/or canned soda and other containers. Many known prior art vending machines are expensive and include complicated and costly mechanisms for storing and dispensing bottles. In addition, the known dispensing and vending mechanisms for dispensing bottles must be loaded from the front because of existing designs. When a vending or merchandising machine is loaded from the front, the product that is next to be dispensed will be the product which has been last placed in the machine which product can be warm. This is not acceptable since most products such as beverages are best ingested at 36-38 degrees. Thus, when a route person services these machines to refill the machine correctly, he has to remove any existing product that is in the dispensing rack, place new product in at the back of the rack, i.e. the warm product, and then replace the original chilled product back so that it is next to be vended. This involves a lot of time on location and is very expensive. If the route person who services the machine does not remove the product and place the new product in the back of the dispensing racks, then expiration of product becomes a concern as the older products are now located in the back of the dispensing racks. If a route person were to refill the machine several times without rotating product, then some product such as milk and juices will be in an expired state which could result in either ingestion by the public of expired product or throwing out of product which is not vended within the proscribed time period.

The present invention overcomes the problems with the prior art by enabling the vending rack to be rotated 180° about a vertical axis to a position in which the back of the dispensing racks are located at the front of the storage cabinet to facilitate loading of the plurality of dispensing racks with product to be vended. Thus, a route person who services the machine simply opens the door of the machine, rotates the dispensing rack, fills the rack with new product, and then rotates the vending rack back to its original position. This results in product being dispensed in a first in and first out fashion and warm product being placed at the back of the dispensing racks so that it is dispensed sequentially after any cooler product in the front of the dispensing racks is dispensed.

### SUMMARY OF INVENTION

The present invention provides a simple, low cost vending or merchandising machine for dispensing bottles and/or containers which are supported in an upright position and which includes a vending rack which is rotatable about a vertical axis at least 180° to a position in which the back of the vending rack is located adjacent to the front of the storage cabinet to facilitate loading of the machine with bottles and/or containers to be vended.

The present invention further provides a new and improved vending machine for vending a plurality of bottles which are supported in an upright position including a storage cabinet having a door on the front which provides access to the interior of the storage cabinet, a vending rack having a plurality of substantially parallel dispensing racks supported therein for supporting a plurality of bottles in an upright position with each of the dispensing racks including at least a single elongated slot for storing and dispensing bottles from the dispensing rack. The vending rack has a front which is located adjacent the door of the storage cabinet when the vending rack is in a position to dispense bottles and a back and a support is provided for supporting the vending rack in the storage cabinet for rotation about a vertical axis to enable the back of the vending rack to be rotated to be located adjacent the front of the storage cabinet to facilitate loading of the plurality of dispensing racks with bottles to be vended. A gate member may be provided for controlling movement of the bottles through the slot. The gate member has a blocking position in which the gate member blocks movement of bottles from the slot and a dispensing position in which the gate member enables the next bottle to be vended to move from the slot from the dispensing rack. A crediting mechanism is connected to the gate member to effect movement of the gate member from its blocking position to its dispensing position when a credit of a predetermined value is received in the crediting mechanism to enable the next bottle to be vended to move from the slot to be dispensed from the dispensing rack.

Still another provision of the present invention is to provide a new and improved vending machine for vending a plurality of bottles each of which is supported in an upright position only at a top portion including a storage cabinet having a door on the front which provides access to the interior of the storage cabinet and a vending rack having a plurality of substantially parallel dispensing racks supported therein. Each of the dispensing racks has at least a single elongated slot for storing and dispensing bottles from the dispensing rack which bottles each include a top portion which is engaged by and supported in the slot in the dispensing rack. The slot includes a pair of substantially parallel spaced apart side walls which terminate at one end thereof in an opening from which bottles may be dispensed from the dispensing rack. The pair of substantially parallel spaced apart side walls are spaced apart a distance which is less than the diameter of the top portion of the bottles which are supported in the elongated slot to prevent bottles from falling from the slot. The opening in the dispensing rack is larger than the diameter of the top portion of the bottles which are supported in the slot to enable bottles to move from the slot to the opening to be dispensed from the dispensing rack. The vending rack has a front which is normally located adjacent the door of the storage cabinet when the vending rack is in a position to dispense bottles and a back. A support is provided for supporting the vending rack for rotation about a vertical axis with the vending rack being rotatable at least 180° to enable the vending rack to be rotated to a position in which the back of the vending rack is located adjacent the front of the storage cabinet to facilitate loading of the plurality of dispensing racks with bottles to be vended. A gate member is provided for controlling movement of the bottles through each of the slots to the opening. A locking member is provided to lock the gate member to prevent the gate member from moving from a blocking position in which the gate member blocks movement of bottles from the slot to the opening to a dispensing position in which the gate member enables the next bottle to be vended to move from the slot to the opening. A crediting mechanism is connected to the locking mechanism to unlock the locking mechanism when a credit of a predetermined value is received in the crediting mechanism. The crediting mechanism is actuated to unlock the locking mechanism to allow the gate member to move from the blocking position to the dispensing position to enable the next bottle to move from the slot to the opening to be dispensed from the dispensing rack.

Still another provision of the present invention is to provide a machine for dispensing bottles which are supported in an upright position only at a top portion of each of the bottles including a storage cabinet having a door on the front of the storage cabinet which provides access to the interior of the storage cabinet, a vending rack and a plurality of substantially parallel dispensing racks supported by the vending rack with each of the dispensing racks having at least a single elongated slot located therein for storing and dispensing bottles from the dispensing rack which bottles each include a top portion which is engaged by and supported by the slot in the dispensing rack. The slot includes a pair of substantially parallel spaced apart side walls which terminate at one end in an opening in the dispensing rack from which bottles may be dispensed. The vending rack has a front which is located adjacent to the door of the storage cabinet when the vending rack is in the position to dispense bottles and a back. A support is provided for supporting the vending rack in the storage cabinet for rotation about a vertical axis with the vending rack being rotatable about the vertical axis at least 180° to enable the back of the vending rack to be located adjacent the front of the storage cabinet to facilitate loading of the plurality of dispensing racks with bottles to be vended.

A still further provision of the present invention is to provide a new and improved machine for dispensing a plurality of bottles supported in an upright position including a storage cabinet having a door on the front of the storage cabinet which provides access to the interior of the cabinet, a vending rack and a plurality of substantially parallel dispensing racks supported by the vending rack. Each of the dispensing racks has at least a single elongated slot for positioning and guiding bottles which bottles each include a top portion which is engaged by and guided by the slot. The slot has an opening at one end to enable bottles which are guided in the slot to move from the slot and the dispensing rack to be dispensed. The vending rack has a front which is located adjacent the door of the storage cabinet when the vending rack is in the position to dispense bottles and a back and a support is provided for supporting the vending rack in the storage cabinet for rotation about a vertical axis with the vending rack being rotatable at least 180° about the vertical axis to enable the back of the vending rack to be rotated to be located adjacent the front of the storage cabinet to facilitate loading of the plurality of dispensing racks with bottles to be vended.

Still another provision of the present invention is to provide a new and improved machine for dispensing a plurality of containers such as beverage cans or bottles which are supported in an upright position including a storage cabinet having a door on the front which provides access to the interior of the storage cabinet, a vending rack and a plurality of substantially parallel dispensing racks supported by the vending rack. Each of the dispensing racks has at least a single elongated slot for locating and guiding containers which are supported in a vertical position. The slot has an opening at one end to enable containers located in the slot to move from the slot in the dispensing rack to be dispensed and an opening at the other end to facilitate loading of the dispensing rack with containers to be dispensed. The vending rack has a front which is located adjacent the door of the storage cabinet when the vending rack is in a position to dispense containers and a back. A support is provided for supporting the vending rack in the storage cabinet for rotation about a vertical axis with the vending rack being rotatable at least 180° about the vertical axis to enable the back of the vending rack to be rotated to face the front of the storage cabinet to facilitate loading of the plurality of dispensing racks with containers to be vended via the openings at the other end of the slot.

A further provision of the present invention is to provide a new and improved machine for dispensing a plurality of containers such as beverage cans or bottles as is set forth in the preceding paragraph further including a plurality of substantially parallel support racks one of which is associated with each of said plurality of dispensing racks for supporting the bottom of the containers which are engaged by and guided by the slot in each of the dispensing racks and wherein the slot engages and guides the top portion of each of the containers which are supported by said support rack.

Still another provision of the present invention is to provide a new and improved machine for dispensing a plurality of containers each of which is supported in an upright position including a storage cabinet having a vending rack therein which supports a plurality of support racks for supporting the bottom of the containers to be dispensed and wherein a support is provided for supporting the vending rack for rotation about a vertical axis at least 180° to enable the back of the vending rack to be rotated to be located adjacent the front of the storage cabinet to facilitate loading of the support racks with containers to be dispensed.

### BRIEF DESCRIPTION OF THE DRAWINGS

FIG. 1 is a front view of a vending machine constructed in accordance with the present invention showing the front door in its open position and more fully illustrating the vending rack.

FIG. 2 is a front view of the vending machine similar to FIG. 1 wherein each of the dispensing racks are filled with bottles to be vended.

FIG. 3 is a cross-sectional view of a dispensing rack having product to be vended therein.

FIG. 4a-4d illustrate a top view of the vending machine showing the sequential rotation of the vending rack from a vend position in FIG. 4a in which the front of the vending rack is located adjacent the door of the storage cabinet to a load position in FIG. 4d in which the back of the vending rack is disposed adjacent the front of the storage cabinet to facilitate loading of the dispensing racks with bottles.

FIG. 5 is a front view of the machine showing the vending rack rotated 180° to its position illustrated in FIG. 4d in which the back of the vending rack is located adjacent the front of the storage cabinet to facilitate loading of product therein.

FIG. 6 is an enlarged fragmentary view of a back portion of a dispensing rack with product loaded therein.

FIGS. 7 is an enlarged fragmentary view of the top of the storage cabinet and vending rack more fully illustrating the alignment axle which supports the top of the vending rack for rotation.

FIG. 8 is a fragmentary side view of the bottom of the storage cabinet more fully illustrating the bottom support for supporting the vending rack for rotation in the storage cabinet.

FIG. 9 is a front view of another embodiment of the present invention utilized in a vending and/or merchandising machine for dispensing containers such as bottles or beverage cans in an upright vertical orientation.

FIG. 10 is a perspective view of the machine of FIG. 9 more fully illustrating the vending rack, the support racks and the dispensing racks supported thereby and illustrating the vending rack rotated approximately 45° from its position illustrated in FIG. 9.

FIG. 11 is a side view of the machine illustrated in FIG. 9 illustrating the vending rack rotated 90°.

FIG. 12 is a fragmentary side view of one of the dispensing racks and the support rack associated therewith.

FIG. 13 is a fragmentary side view of the dispensing racks and the support rack associated therewith wherein beverage cans are vended and/or dispensed from the dispensing rack.

FIG. 14 is a side view of another embodiment of a support rack which can be supported by the vending rack.

FIG. 15 is a sectional view of the support rack of FIG. 14 taken approximately along lines 15-15 of FIG. 14.

FIG. 16 is a side view of a support rack similar to FIG. 14 illustrating the support rack loaded with cans to be dispensed.

### DESCRIPTION OF THE PREFERRED EMBODIMENT

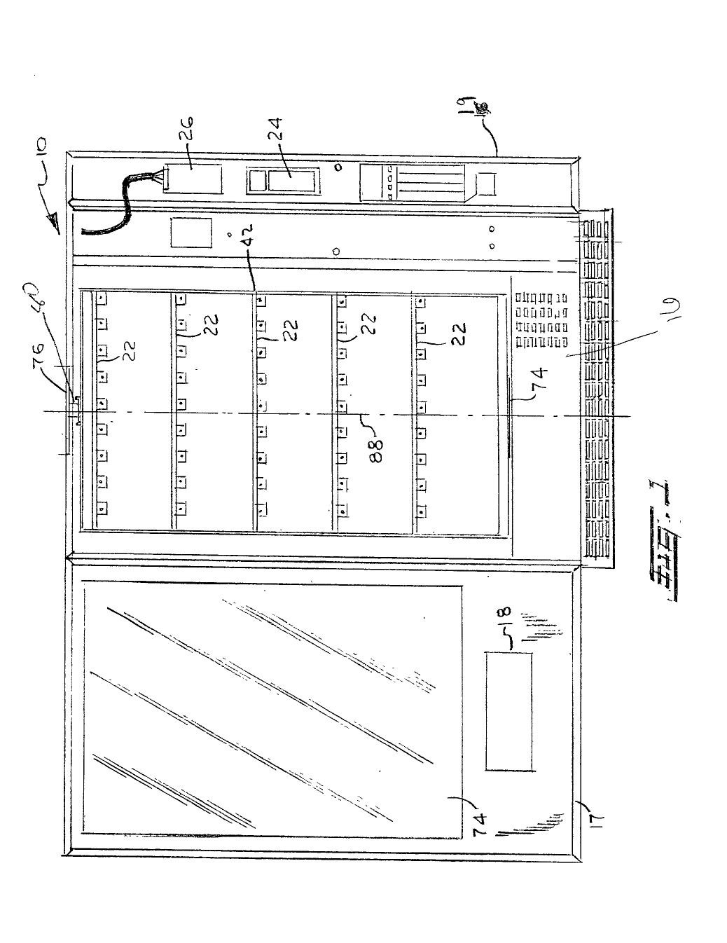

Referring to the figures and more particularly to FIG. 1, a vending machine 10 constructed in accordance with the present invention is illustrated. The vending machine 10 is particularly designed to vend bottles 12 which are supported in an upright position only at a top portion 14 of the bottles and includes a cabinet 16 having a bottle dispensing station 18 disposed therein. A compressor, not illustrated, is located within the storage cabinet 16 to cool the bottles 12 stored therein in a well known manner. The storage cabinet includes a door 17 on the front of the storage cabinet 16 which can be opened to provide access to the interior of the storage cabinet in a well known manner. The door 17 is illustrated in its open position in FIG. 1. When a bottle 12 is to be vended the bottle is moved to the bottle dispensing station 18 where the bottle can be removed from the vending machine 10 by a purchaser.

A plurality of planar dispensing racks 22 are located in the storage cabinet 16 for storing a plurality of bottles 12 within the cabinet 16. A coin or credit mechanism 24 is located on the front of the storage cabinet 16 on a door 19 illustrated in its open position in FIG. 1 and includes a key pad 26 for selecting a particular selection to be vended from the dispensing racks 22 of the vending machine 10. The crediting mechanism 24 can be a coin mechanism or other type of crediting mechanisms such as those that receive credit cards or dollar bills. When a proper credit is received, the key pad 26 is actuated to select a product to be vended and the selected product is then dropped from the dispensing rack 22 to the dispensing station 18 where the product is removed from the machine.

The cabinet door 17 includes a window 74 which, when the door is in its closed position, is disposed adjacent the front of the dispensing racks 22 to allow viewing of the bottles 12 disposed in the dispensing racks 22. Each of the selections in the dispensing racks 22 will include an associated designation which can be entered into the key pad 26 to select the desired selection in a well known manner.

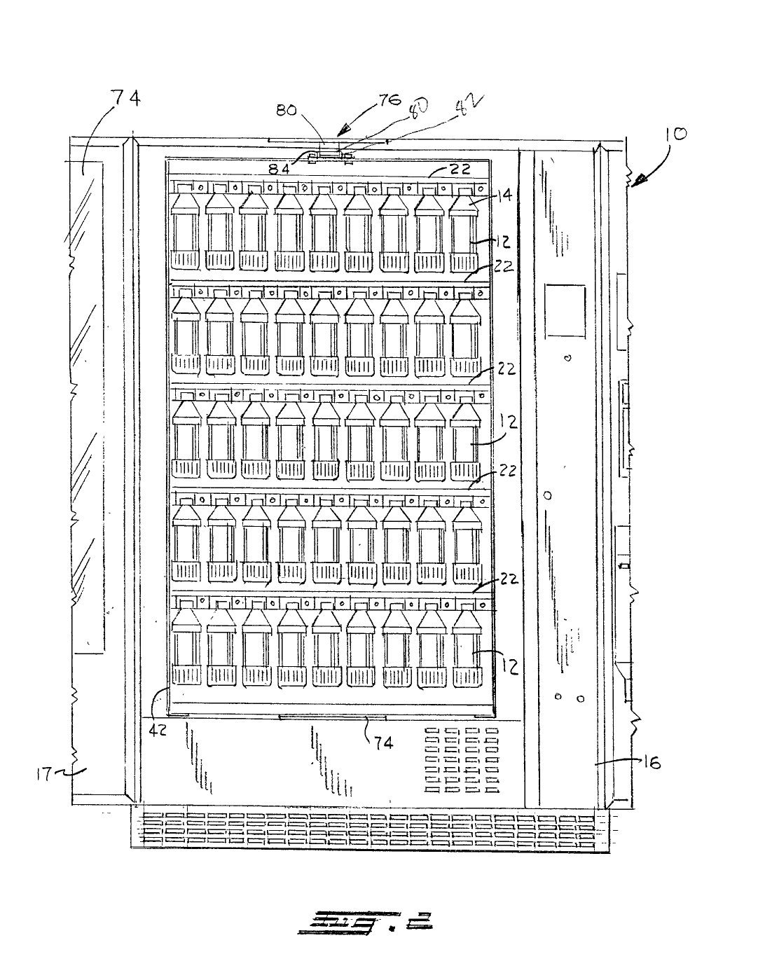

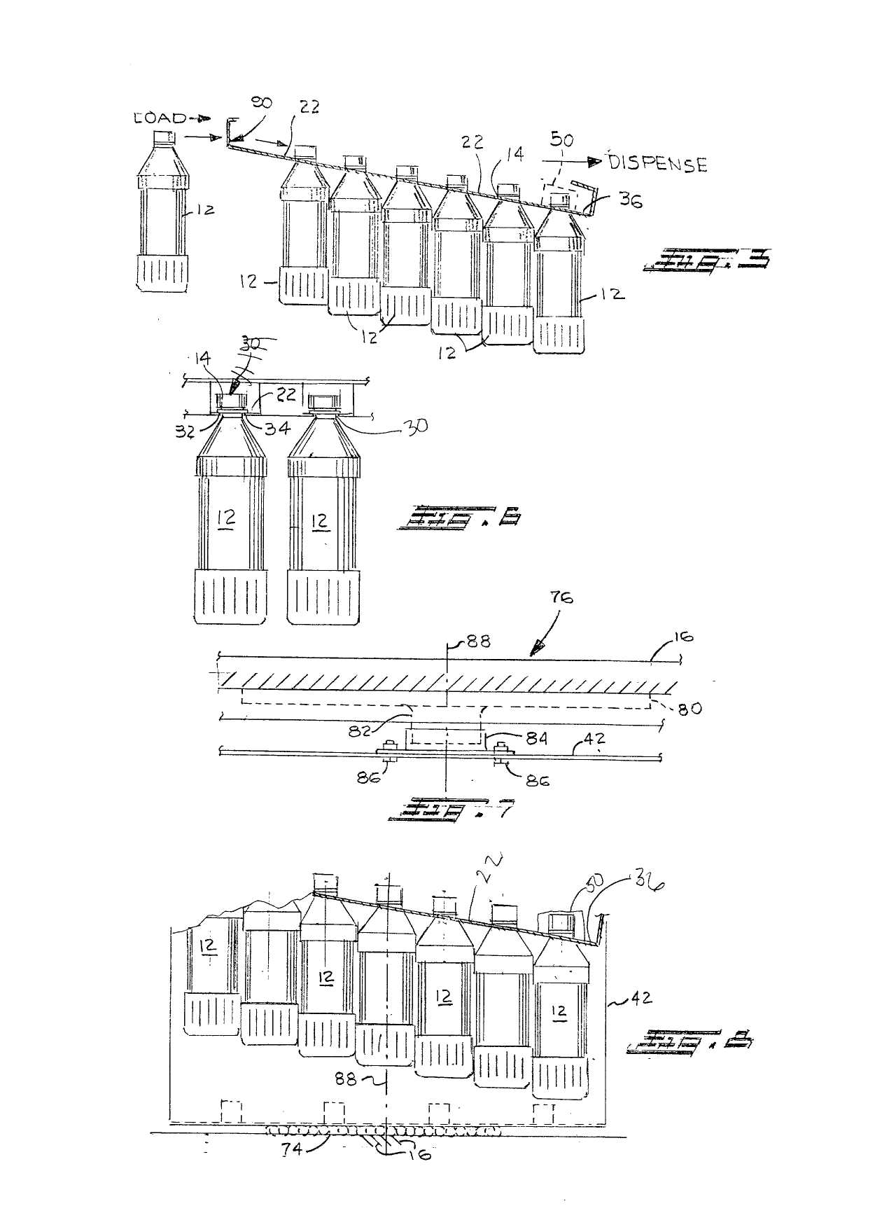

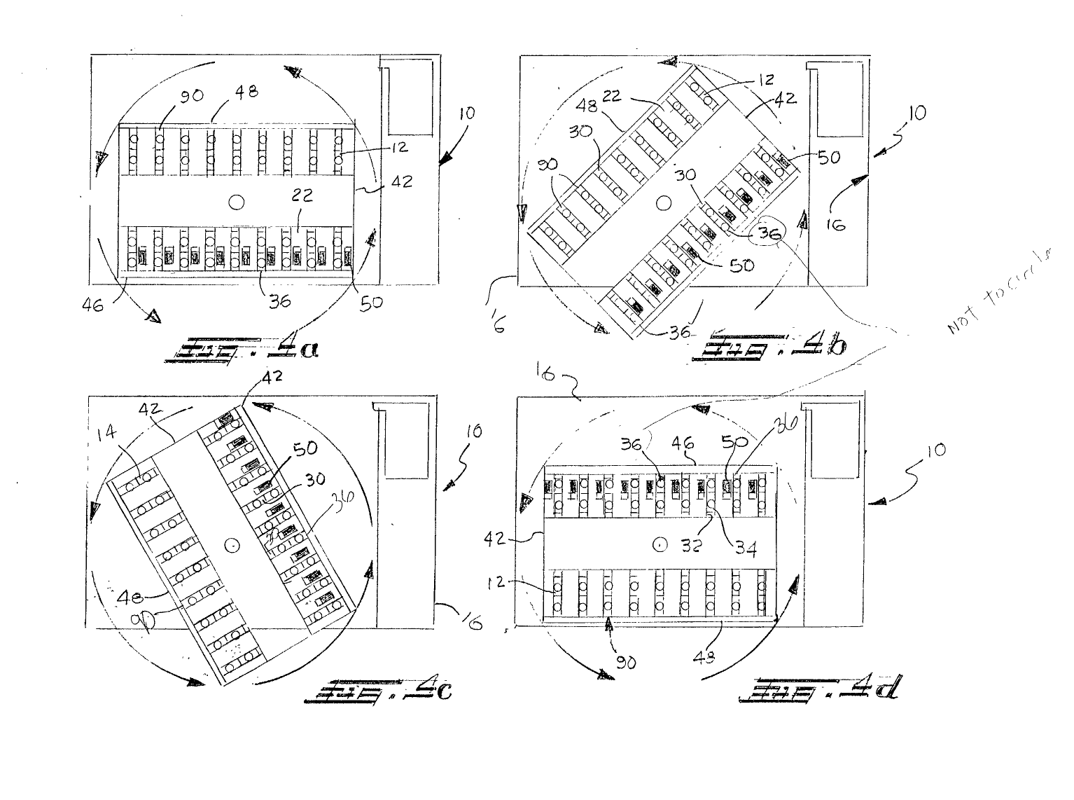

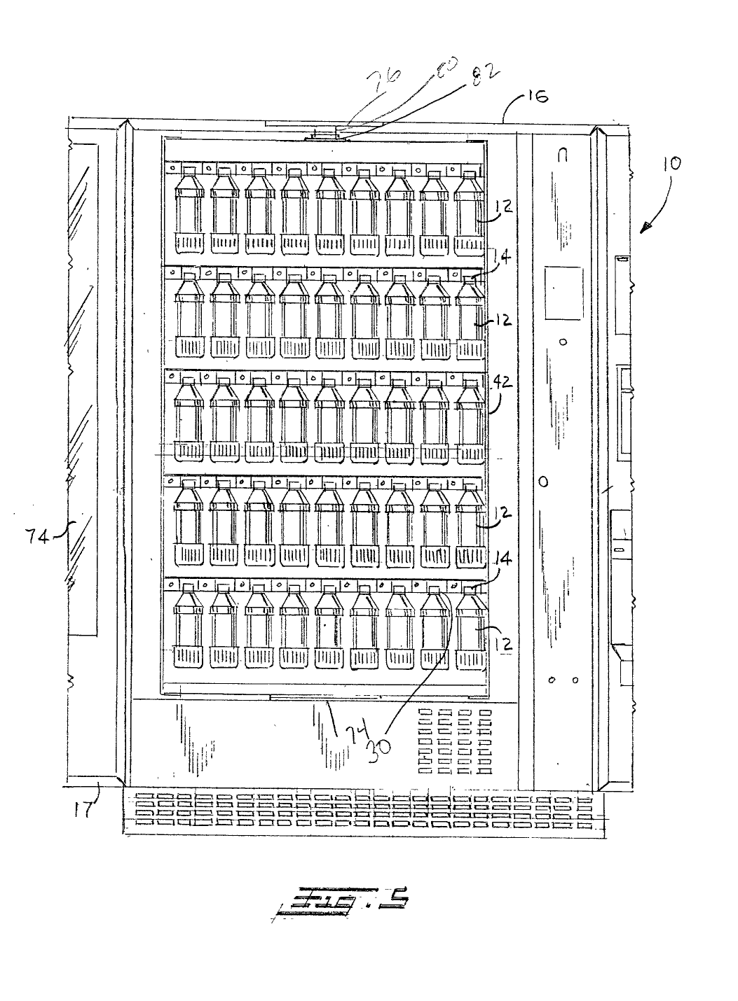

Each of the planar dispensing racks 22 is adapted to store a plurality of bottles to be vended therein. FIGS. 3 and 4 more fully illustrate the planar construction of each of the dispensing racks 22. Each of the dispensing racks include a plurality of elongate slots 30 for storing and dispensing bottles from the planar dispensing rack 22. The plurality of elongated slots 30 are substantially parallel to each other and each include a pair of spaced apart substantially parallel side walls 32, 34 which are spaced apart a distance which is smaller than the diameter of the top portion 14 of the bottles to be supported in the planar dispensing rack 22. The side walls 32, 34 of each of the slots 30 terminate at one end in an opening 36 which is larger than the top portion 14 of the bottles which are supported in the elongated slot 30. It should be appreciated that the opening 36 does not have to be a continues circular opening and could be any type of construction in which the side walls 32, 34 diverge away from each other to enable bottles supported in the slots 30 to be dispensed therefrom.

Each of the planar dispensing racks 22 is inclined in the preferred embodiment, approximately 15° from horizontal in a downwardly direction toward the openings 36 located at the one end of the slots as is more fully illustrated in FIG. 3. When the plurality of bottles 12 are located in the elongated slots 30, the bottles slide solely under the influence of gravity toward the one end of the dispensing rack at which the openings 36 are located.

Each of the plurality of dispensing racks 22 are supported in a storage cabinet 16 by a vending rack 42. In the preferred embodiment, the vending rack 42 has a generally rectangular configuration and supports each of the plurality of dispensing racks 22 in a generally parallel horizontal position which is inclined as aforesaid, within the vending rack 42.

A plurality of gate members 50 are disposed on each of the dispensing racks 22 adjacent one end of the slots 30 at the juncture of the slot 30 and the opening 36 for controlling sliding movement of the bottles 12 through slot 30 into the opening 36. The gate member 50 has a blocking position, not illustrated, wherein the gate member 50 engages the next bottle 12 to be vended and prevents movement of the next bottle to be vended from the slot 30 into the opening 36 and a dispensing position, not illustrated, in which the gate member 50 enables movement of the next bottle 12 through the slot 30 to allow the next bottle to be vended to move into the opening 36 from which the next bottle may be dispensed. The construction and operation of the gate member 50 and each of the dispensing racks 22 is more fully illustrated in U.S. Pat. No. 6,112,943 assigned to the same Assignee as the present invention which is incorporated herein by reference. A locking mechanism, not illustrated, but more fully disclosed in U.S. Pat. No. 6,112,943 which is incorporated herein by reference can be provided to lock movement of the gate member 50 to prevent the gate member 50 from moving from its blocking position to its dispensing position. The locking mechanism can be actuated by the coin mechanism 24 in a well known manner when a credit of a predetermined value is received to move the locking mechanism to a position in which the gate member 50 is free to move from its blocking to its dispensing position to enable a bottle to be vended.

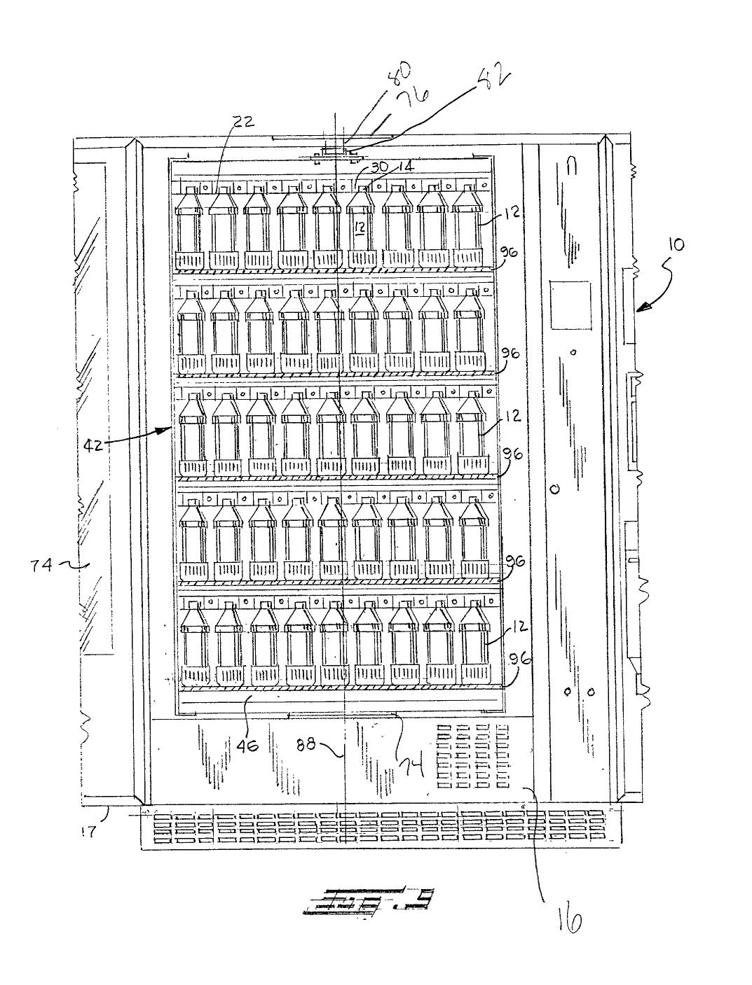

The vending rack 42 more fully illustrated in FIGS. 1 and 4 supports each of the plurality of dispensing racks 22 for movement therewith. The plurality of dispensing racks 22 are rigidly supported by the vending rack 42 to form a unitary structure which is supported within the storage cabinet 18 by a support means which includes the supports 74 and 76. The support 74, more fully illustrated in FIG. 8, is a ball bearing turntable 74 which is located at the bottom of the storage cabinet 16. The turntable 74 is attached to the bottom of the vending rack 42 and supports vending rack 42 for rotation within cabinet 16. The support 76, more fully illustrated in FIG. 7, includes an alignment member 80 which is supported by the top of the storage cabinet 16. The alignment member 80 includes an alignment axle 82 which is received within a sleeve 84 secured by the bolt members 86 to the top of the vending rack 42. The supports 74 and 76 support the vending rack 42 for rotation about the vertical axis 88 within the storage cabinet 16. The vending rack 42, as is illustrated in FIGS. 4a-d, is rotatable about the vertical axis 88 from a vend position shown in FIG. 4a in which the front 46 of the vend rack 42 is located adjacent the door 17 of the machine 10 to a position shown in FIG. 4d in which the back 48 of the vend rack 42 is disposed adjacent the front of the storage cabinet 18 to facilitate loading of containers to be vended.

Each of the slots 30 in each of the dispensing racks 22 include an opening 36 at one end through which a container may be dispensed and an opening 90 at the opposite end thereof adjacent the back 48 of the vend rack 42 for enabling containers to be loaded in the slots 30 of the dispensing rack.

The dispensing rack has a normal dispensing position when located in its position illustrated in FIGS. 2 and 4a. In this position, a container can be vended when a proper credit is received in the crediting mechanism 24, and a product is selected via the key pad 26 to actuate the gate member 50 to enable the selected product to drop from the slot to the dispensing station 18 where it is accessible by a purchaser. When it is desired to load the vending rack 42 with new product to be vended, the door 17 of the storage cabinet 18 is opened and the vending rack 42 along with its supported dispensing racks 22 are rotated as viewed in FIG. 4 in a counterclockwise direction 180° from its position illustrated in FIG. 4a to its position illustrated in FIG. 4d. When the vending rack 42 is located in its load position illustrated in FIG. 4d, the back 48 of the vending rack 42 is disposed adjacent the front of the storage cabinet 16 to facilitate loading of the plurality of dispensing racks 22 with containers to be vended. When the vending rack 42 is in its position illustrated in FIG. 4d, the openings 90 in each of the slots 30 of the dispensing racks 22 are now disposed adjacent the front of the storage cabinet 16 and containers can be loaded into the dispensing racks 22 when the door 17 is opened. After containers are loaded in the dispensing rack, the dispensing rack is rotated back to its position illustrated in FIG. 4a in a position in which the vending rack 42 is in a position to dispense product.

Rotation of the vending rack 42 about the vertical axis 88 from its position illustrated in FIG. 4a to its position illustrated in FIG. 4d overcomes the many disadvantages associated with prior art vending and merchandising machines by allowing product to be loaded and dispensed in a first in first out fashion in which product which is first loaded into the dispensing racks 22 is vended before product which is subsequently loaded into the dispensing racks 22.

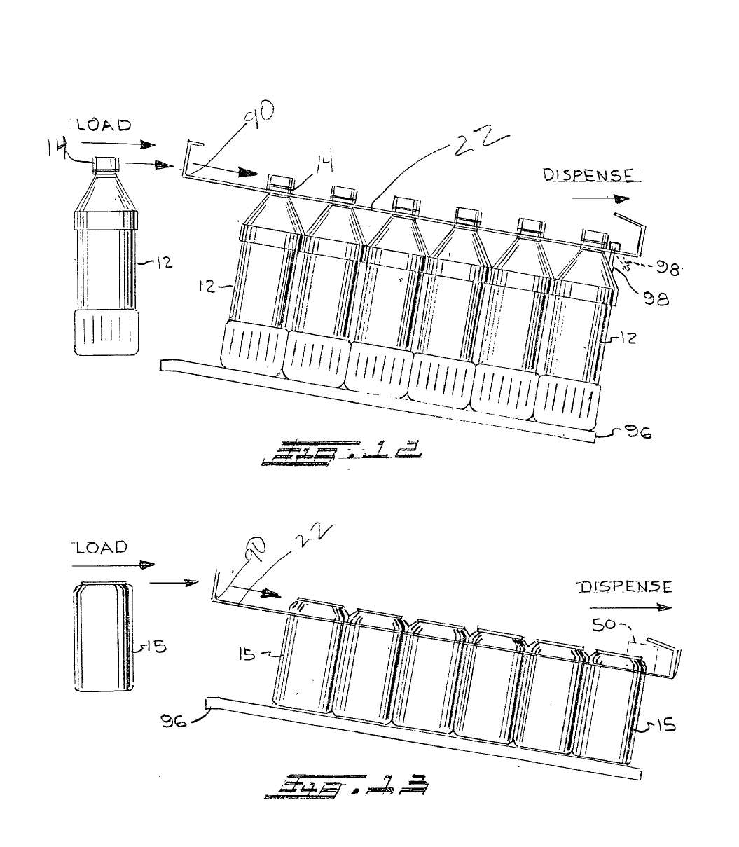

While the preferred embodiment of the invention has been illustrated in a vending machine in which bottles 12 are sequentially vended after a credit of a predetermined value is received in the machine, it should be appreciated that the present invention is equally adaptable to a merchandiser which supports a plurality of bottles 12 in an upright position in slots 30 in a plurality of dispensing racks 22 which are supported in a vend rack 42. Merchandisers for merchandising bottles which are supported in a vertical position are well known and are sold by H.S. Beverage Merchandising of Englewood, N.J., by E.C.C. Vending Products and Mead of Atlanta, Ga. A merchandiser differs from a vending machine in that in a merchandiser a product can be removed from the storage cabinet 16 without paying via a crediting mechanism 24. In a merchandiser when it is desired to dispense product, the door 17 is opened and a customer removes the desired product from a selected slot 30 in a dispensing rack 22. In such a merchandising machine, a gate member 98, see FIG. 12, can be utilized to prevent the bottles 14 from sliding out of the openings 36 in the dispensing rack without being engaged by a purchaser. The gate member 98 holds bottles 12 in the slot 30 of the dispensing rack 22 and can be spring biased to its full line position in FIG. 12 and can move to its phantom line position illustrated in FIG. 12 when a bottle 12 is removed from the machine. Other well known types of gates can be utilized to control movement of the containers through the slots 30 in the dispensing racks 22. The gates can be of the type utilized in the Mead Necktracker or the Neck Glide System sold by H.S. Beverage. Both of these machines utilize a track which support the top portion of bottles and which includes a resilient gate mechanism at the dispensing end of the track which normally supports a bottle to be dispensed. When a customer desires to remove a bottle from the track, the bottle is grasped by the customer and the resilient gate member is overcome by the customer moving the bottle to allow the bottle to be removed from the track through the gate.

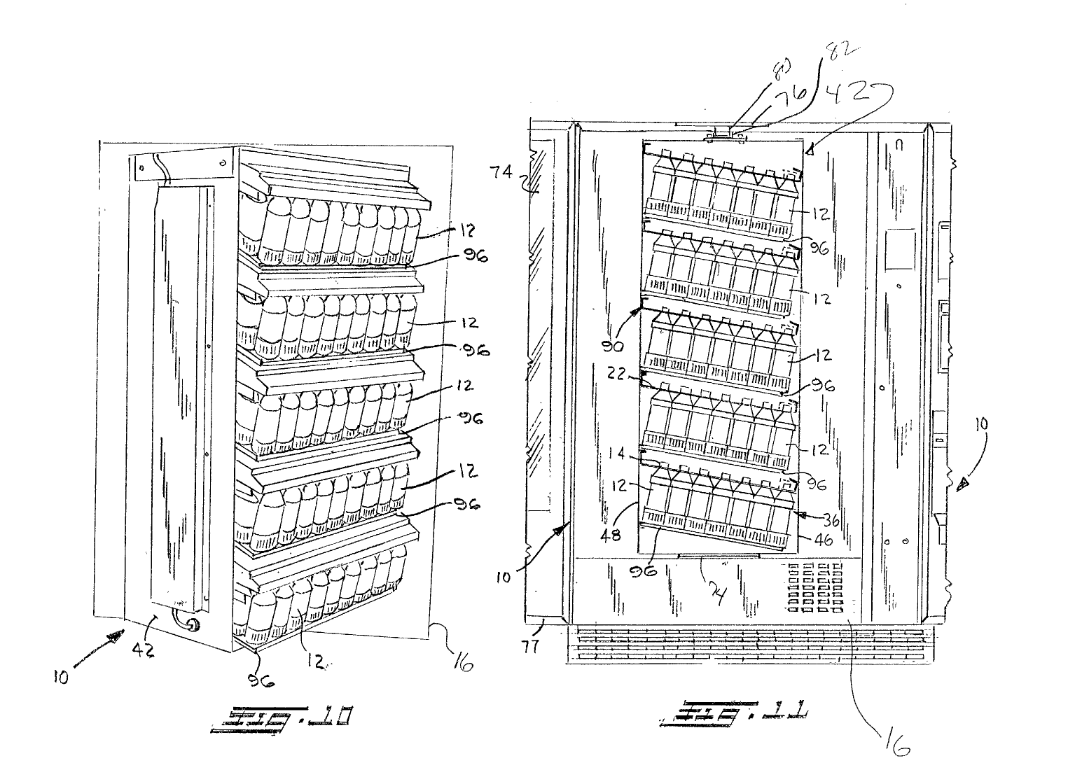

While the preferred embodiment of the invention has been illustrated as vending or dispensing bottles which are supported in an upright vertical position by a top portion 14 of the bottles in the slots 30, other embodiments of the invention can be utilized to vertically orient other types of containers such as beverage cans or bottles by guiding the top portion thereof while supporting the containers by the bottom. For example, FIGS. 9-13 illustrate a further embodiment of the invention in which bottles 12 or cans 15 are located and guided within slots 30 located in the dispensing rack 22 supported by the vend rack 42. In this embodiment, a gate mechanism similar to gate member 50 can be utilized to control movement of the containers through the slots 22 or a gate mechanism such as the resilient gate mechanism described hereinabove can be utilized, depending on whether the machine 10 is to be utilized as a vending machine or a merchandiser.

In the vending and/or merchandising machine illustrated in FIG. 9, the vend rack 42 is rotatable about a vertical axis 88 to enable the back 48 of the vending rack 42 to be rotated to be located adjacent the front of the storage cabinet 16 to facilitate loading of containers such as bottles 12 or cans 15 to be vended to a fifo (first in first out) fashion.

The vending machine or merchandising machine 10 illustrated in FIGS. 9-13 includes a plurality of support shelves or racks 96 which are supported in the vending rack 42. Each of the plurality of support racks 96 is associated with one of the plurality of dispensing racks 22 to support the containers which are located and guided by the dispensing racks 22. In this embodiment of the invention, the top portions of the containers are not supported by the dispensing racks 22, but rather the bottom of the container, either a can 15 or a bottle 12, is supported by the support rack 96 and the top portion of the bottle 12 or can 15 is located and guided in the elongated slot 30 disposed in the dispensing rack 22. Each of the plurality of support racks 96 is inclined from a horizontal position and is substantially parallel to its associated dispensing rack 22 to enable the containers supported on the support rack 96 and located within the slots 30 of the dispensing rack 22 to slid under the influence of gravity to the front 46 of the vending rack 42 where the containers can be dispensed. The vending rack 42, the dispensing racks 22 and the support racks 96 move as a unitary structure and are rotatable about the vertical axis 88 to locate the back 48 of the vending rack 42 adjacent the front of the storage cabinet to facilitate loading of the dispensing racks 22 with either cans 15 or bottles 12 to be vended. Supports such as illustrated in FIGS. 7 and 8 are utilized to support the vending rack 42 for rotation about vertical axis 88.

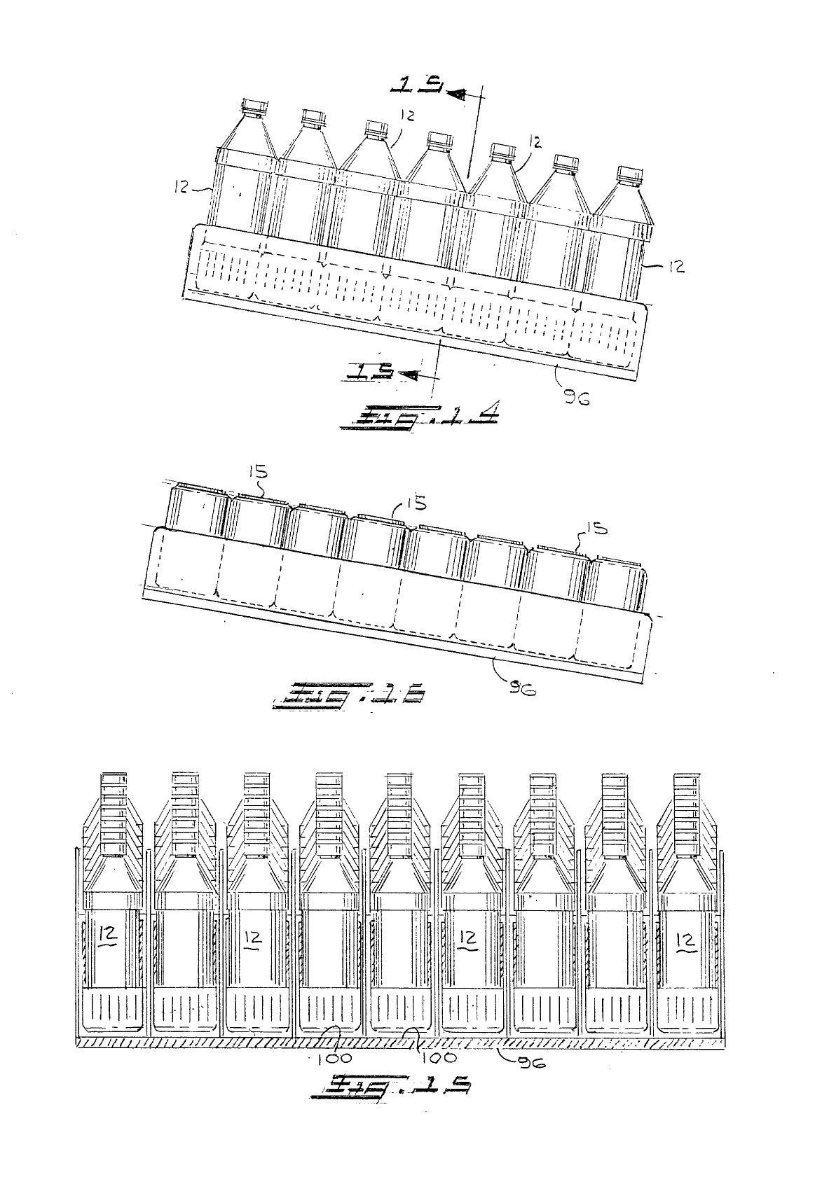

A further embodiment of the invention is disclosed in FIGS. 14-16 which is similar to that disclosed in FIGS. 9-13 except that the dispensing racks 22 have been eliminated and the bottles 12 or cans 15 are supported and guided solely by the support racks 96. A plurality of parallel channels 100 are provided in the support racks 96 to guide and support the bottom of bottles or cans which are supported by the support rack 96. The support rack 96 are all supported by a vend rack 42 which is supported for rotation about the vertical axis 88.

From the foregoing, it should be apparent that a new and improved machine for dispensing a plurality of containers such as bottles 12 or cans 15 which are supported in an upright position has been provided. The machine includes storage cabinet 16 including a door 17 on the front of the storage cabinet 16 which provides access to the interior of the storage cabinet, and a vending rack 42 having a plurality of substantially parallel dispensing racks 22 and a plurality of substantially parallel support shelves 96 supported thereby. Each of the dispensing racks includes at least a single elongated slot 30 located therein for positioning the bottles or containers located in the slots 30 in the dispensing rack 22 which containers each include a top portion which is guided by the slot to orient the containers in a vertical position. The slot 30 has an opening 36 at one end to enable the containers which are located in the elongated slot 30 in the dispensing rack 22 to move from the slot 20 and the dispensing rack 22 to be dispensed. An opening 90 is provided at the other end of the slot 30 to facilitate loading of the dispensing rack 22 with containers to be dispensed. The vending rack 42 has a front 46 which is located adjacent the door 17 of the storage cabinet 16 when the vending rack 42 is in a position to dispense containers and a back 48. A support is provided for supporting the vending rack in the storage cabinet 16 for rotation about vertical axis 88. The support includes a ball bearing turntable 74 for supporting the bottom of the vending rack 42 and a alignment axle 82 received in a coupling 84 disposed on the top of the vending rack 42 to support the vending rack 42 for rotation about vertical axis 88 to enable the back 48 of the vending rack 42 to be rotated to be located adjacent the front of the storage cabinet 16 to facilitate loading of the plurality of dispensing racks 22 with containers to be vended through the opening 90 at the other end of the slot 30 located in the dispensing rack 22.

I claim:

1. A vending machine for vending a plurality of bottles each of which are supported in an upright position comprising a storage cabinet including a door on the front of the storage cabinet which provides access to the interior of the storage cabinet, a vending rack having a plurality of substantially parallel dispensing racks supported therein, each of said dispensing racks being adaptable to support a plurality of bottles in an upright position, each of said dispensing racks including at least a single elongated slot located therein for storing and dispensing bottles from said dispensing rack, said vending rack having a front which is located adjacent the door of said storage cabinet when said vending rack is in a position to dispense bottles and a back, a support for supporting said vending rack in said storage cabinet for rotation about a vertical axis, said vending rack being rotatable about said vertical axis at least 180° to enable the back of the vending rack to be located adjacent to the front of the storage cabinet to facilitate loading of the plurality of dispensing racks with bottles to be vended, a gate member for controlling movement of the bottles through each of said slots in said dispensing rack, said gate member having a blocking position in which said gate member blocks movement of bottles from the slot and a dispensing position in which said gate member enables the next bottle to be vended to move from the slot from the dispensing rack to be vended, and a crediting mechanism connected to the gate member to effect movement of the gate member from its blocking position to its dispensing position when coins or a credit of a predetermined value are received in the crediting mechanism to enable the next bottle to be vended to move from slot to be dispensed from the dispensing rack.

2. A vending machine for vending a plurality of bottles as defined in claim 1 wherein each of said dispensing racks is inclined from a horizontal position in a downwardly direction toward said front of said vending rack to enable bottles supported in said slot in said dispensing rack to move under the influence of gravity through said slot in the dispensing rack to the front of said vending rack.

3. A vending machine for vending a plurality of bottles as is defined in claim 1 wherein each of said slots in said dispensing rack includes an opening in said slot located adjacent the back of the vending rack for loading bottles to be vended.

4. A vending machine for vending a plurality of bottles as is defined in claim 1 wherein said support for supporting said vending rack for rotation about a vertical axis includes a bearing assembly operatively associated with the bottom of the vending rack and the storage cabinet for supporting said vending rack in said storage cabinet for rotation relative to said storage cabinet about said vertical axis.

5. A vending machine for vending a plurality of bottles as is defined in claim 4 wherein said support for supporting said vending rack for rotation about a vertical axis further includes a coupling operatively associated with the top of said vending rack and an alignment axle disposed on the top of the storage cabinet and received in said coupling to support the top of said vending rack for rotation about said vertical axis and to support the top of said vending rack in vertical alignment with said bearing assembly.

6. A vending machine for vending a plurality of bottles each of which is supported in an upright position only at a top portion of each of the bottles comprising a storage cabinet including a door on the front of the storage cabinet which provides access to the interior of the storage cabinet, a vending rack having a plurality of substantially parallel dispensing racks supported therein, each of said dispensing racks having at least a single elongated slot located therein for storing and dispensing bottles from said dispensing rack which bottles each include a top portion which is engaged by and supported by said slot in said dispensing rack, said slot including a pair of substantially parallel spaced apart side walls which terminate at one end thereof in an opening from which bottles may be dispensed from said dispensing rack, said pair of substantially parallel spaced apart side walls being spaced apart a distance which is less than the diameter of the top portion of the bottles which are supported in said elongated slot to prevent bottles from falling from said elongated slot when bottles are supported by said side walls of said slot, said opening in said dispensing rack being larger than the diameter of the top portion of the bottles which are supported in said elongated slot to enable bottles which are supported in said elongated slot to move from said slot into said opening to be dispensed from said dispensing rack, said vending rack having a front which is located adjacent said door of said storage cabinet when said vending rack is in a position to dispense bottles and a back, a support for supporting said vending rack in said storage cabinet for rotation about a vertical axis, said vending rack being rotatable about said vertical axis at least 180° to enable the vending rack to be rotated to a position in which the back of the vending rack is located adjacent the front of the storage cabinet to facilitate loading of the plurality of dispensing racks with bottles to be vended, a gate member for controlling movement of the bottles through each of said slots to said opening, a locking mechanism for locking said gate member to prevent said gate member from moving from a blocking position in which said gate member blocks movement of bottles from said slot to said opening and a dispensing position in which said gate member enables the next bottle to be vended to move from said slot to said opening to be dispensed from said dispensing rack, and a crediting mechanism connected to said locking mechanism to unlock said locking mechanisms when a credit of a predetermined value is received in said crediting mechanism and said crediting mechanism is actuated to unlock said locking mechanism to allow said gate member to move from said blocking position to said dispensing position to enable the next bottle to be vended to move from said slot to said opening to be dispensed from said dispensing rack.

7. A vending machine for vending a plurality of bottles as is defined in claim 6 when each of said dispensing racks is inclined from a horizontal position in a downwardly direction towards said opening in said dispensing rack to enable bottles supported in said slot in said dispensing rack to move under the influence of gravity towards said one end of said slot at which said opening is located.

8. A vending machine for vending a plurality of bottles as is defined in claim 7 wherein each of said slots in said dispensing rack includes an opening in said slot located adjacent the back of the vending rack for loading bottles to be vended.

9. A vending machine for vending a plurality of bottles as is defined in claim 6 wherein said support for supporting said vending rack for rotation about said vertical axis includes a bearing assembly operatively associated with the bottom of the vending rack and the storage cabinet for supporting said vending rack in said storage cabinet for rotation relative to said storage cabinet about said vertical axis.

10. A vending machine for vending a plurality of bottles as is defined in claim 9 wherein said support for supporting said vending rack for rotation about a vertical axis further includes a coupling operatively associated with the top of said vending rack and an alignment axle disposed on the top of the storage cabinet and received in said coupling to support the top of said vending rack for rotation about said vertical axis and to support the top of said vending rack in vertical alignment with said bearing assembly.

11. A machine for dispensing a plurality of bottles each of which are supported in an upright position only at a top portion of each of the bottles comprising a storage cabinet including a door on the front of the storage cabinet which provides access to the interior of the storage cabinet, a vending rack having a plurality of substantially parallel dispensing racks supported thereby, each of said dispensing racks having at least a single elongated slot located therein for storing and dispensing bottles from said dispensing rack which bottles each include a top portion which is engaged by and supported by the slot in said dispensing rack, said slot including a pair of substantially parallel spaced apart side walls which terminate at one end thereof in an opening in said dispensing rack from which bottles may be dispensed, said pair of substantially parallel spaced apart side walls being spaced apart a distance which is less than the diameter of the top portion of the bottles which are supported in said elongated slot to prevent bottles from falling from said elongated slot when bottles are supported by said side walls of said slot, said vending rack having a front which is located adjacent said door of said storage cabinet when said vending rack is in a position to dispense bottles and a back, a support for supporting said vending rack in said storage cabinet for rotation about a vertical axis, said vending rack being rotatable about said vertical axis at least 180° to enable the back of the vending rack to be rotated to be located adjacent the front of the storage cabinet to facilitate loading of the plurality of dispensing racks with bottles to be vended.

12. A machine for dispensing bottles as defined in claim 11 wherein each of said dispensing racks is inclined from a horizontal position in a downwardly direction towards said opening in said dispensing rack from which bottles may be dispensed to enable bottles supported in said slot in said dispensing rack to move under the influence of gravity towards said one end of said slot in which said opening is located, and further including a gate member for controlling movement of the bottles through said slot to said opening.

13. A machine for vending a plurality of bottles as is defined in claim 11 wherein each of said slots in said dispensing rack includes an opening in said slot located adjacent the back of the vending rack for loading bottles to be vended.

14. A machine for vending a plurality of bottles as is defined in claim 11 wherein said support for supporting said vending rack for rotation about a vertical axis includes a bearing assembly operatively associated with the bottom of the vending rack and the storage cabinet for supporting said vending rack in said storage cabinet for rotation relative to said storage cabinet about said vertical axis.

15. A machine for vending a plurality of bottles as is defined in claim 14 wherein said support for supporting said vending rack for rotation about a vertical axis further includes a coupling operatively associated with the top of said vending rack and an alignment axle disposed on the top of the storage cabinet and received in said coupling to support the top of said vending rack for rotation about said vertical axis and to support the top of said vending rack in vertical alignment with said bearing assembly.

16. A machine for dispensing a plurality of bottles each of which are supported in an upright position comprising a storage cabinet including a door on the front of the storage cabinet which provides access to the interior of the storage cabinet, a vending rack having a plurality of substantially parallel dispensing racks supported thereby, each of said dispensing racks having at least a single elongated slot located therein for positioning bottles in said dispensing rack which bottles each include a portion which is engaged by and guided by said slot to orient the bottles in a vertical position, said slot having an opening at one end to enable bottles which are located in said elongated slot in said dispensing rack to move from said slot and said dispensing rack to be dispensed and an opening at the other end of said slot to facilitate loading of the dispensing racks with bottles to be dispensed, said vending rack having a front which is located adjacent the door of said storage cabinet when the vending rack is in a position to dispense bottles and a back, and a support for supporting said vending rack in said storage cabinet for rotation about a vertical axis, said vending rack being rotatable about said vertical axis at least 180° to enable the back of said vending rack to be rotated to be located adjacent the front of the storage cabinet to facilitate loading of the plurality of dispensing racks with bottles to be vended through said opening at said other end of said slot.

17. A machine for dispensing a plurality of bottles as defined in claim 16 further including a plurality of substantially parallel support racks one of which is associated with each of said plurality of dispensing racks for supporting the bottom of the bottles which are engaged by and guided by said slot in each of said dispensing racks and wherein said slot engages and guides the top portion of each of the bottles which are supported by said support rack.

18. A machine for vending a plurality of bottles as is defined in claim 16 wherein said support for supporting said vending rack for rotation about a vertical axis includes a bearing assembly operatively associated with the bottom of the vending rack and the storage cabinet for supporting said vending rack in said storage cabinet for rotation relative to said storage cabinet about said vertical axis.

19. A machine for vending a plurality of bottles as is defined in claim 18 wherein said support for supporting said vending rack for rotation about a vertical axis further includes a coupling operatively associated with the top of said vending rack and an alignment axle disposed on the top of the storage cabinet and received in said coupling to support the top of said vending rack for rotation about said vertical axis and to support the top of said vending rack in vertical alignment with said bearing assembly.

20. A machine for dispensing a plurality of containers each of which are supported in an upright position comprising a storage cabinet including a door on the front of the storage cabinet which provides access to the interior of the storage cabinet, a vending rack having a plurality of substantially parallel dispensing racks supported thereby, each of said dispensing racks having at least a single elongated slot located therein for positioning containers in said dispensing rack which containers each include a portion which is engaged by and guided by said slot to orient the containers in a vertical position, said slot having an opening at one end to enable containers which are located in said elongated slot in said dispensing rack to move from said slot and said dispensing rack to be dispensed and an opening at the other end of said slot to facilitate loading of the dispensing racks with containers to be dispensed, said vending rack having a front which is located adjacent the door of said storage cabinet when the vending rack is in a position to dispense containers and a back, and a support for supporting said vending rack in said storage cabinet for rotation about a vertical axis, said vending rack being rotatable about said vertical axis at least 180° to enable the back of said vending rack to be rotated to be located adjacent the front of the storage cabinet to facilitate loading of the plurality of dispensing racks with containers to be vended through said opening at said other end of said slot.

21. A machine for dispensing a plurality of containers as defined in claim 20 further including a plurality of substantially parallel support racks one of which is associated with each of said plurality of dispensing racks for supporting the bottom of the containers which are engaged by and guided by said slot in each of said dispensing racks and wherein said slot engages and guides the top portion of each of the containers which are supported by said support rack.

22. A machine for dispensing a plurality of containers as defined in claim 21 wherein each of said dispensing racks and each of said support racks is inclined from a horizontal position in a downwardly direction towards the front of said vending rack to enable containers located in said slot in said dispensing rack and supported by said support rack to move under the influence of gravity towards said one end of said slot at which said opening is located.

23. A machine for dispensing a plurality of containers as defined in claim 22 further including a gate member for controlling movement of the containers through each of said elongated slots and through said opening at said one end.

24. A machine for vending a plurality of containers as is defined in claim 20 wherein said support for supporting said vending rack for rotation about a vertical axis includes a bearing assembly operatively associated with the bottom of the vending rack and the storage cabinet for supporting said vending rack in said storage cabinet for rotation relative to said storage cabinet about said vertical axis.

25. A machine for vending a plurality of containers as is defined in claim 24 wherein said support for supporting said vending rack for rotation about a vertical axis further includes a coupling operatively associated with the top of said vending rack and an alignment axle disposed on the top of the storage cabinet and received in said coupling to support the top of said vending rack for rotation about said vertical axis and to support the top of said vending rack in vertical alignment with said bearing assembly.

26. A machine for vending a plurality of containers as is defined in claim 23 wherein said gate member has a blocking position in which said gate member blocks movement of the containers from the elongate slot and a dispensing position in which said gate member enables the next container to be dispensed to move from the slot to be dispensed and further including a crediting mechanism connected to said gate member to effect movement of the gate member from its blocking position to its dispensing position when coins or a credit of a predetermined value are received in the crediting mechanism.

27. A machine for dispensing a plurality of containers as defined in claim 20 further including a gate member for controlling movement of the containers through each of said elongated slots and through said opening at said one end.

28. A machine for dispensing a plurality of containers each of which are supported in an upright position comprising a storage cabinet including a door on the front of the storage cabinet which provides access to the interior of the storage cabinet, a vending rack having a plurality of substantially parallel support racks supported thereby, each of said support racks supporting the bottom of containers supported by the support rack in a vertical position, said vending rack having a front which is located adjacent the door of said storage cabinet when the vending rack is in a position to dispense containers and a back, and a support for supporting said vending rack in said storage cabinet for rotation about a vertical axis, said vending rack being rotatable about said vertical axis at least 180° to enable the back of said vending rack to be rotated to be located adjacent the front of the storage cabinet to facilitate loading of the plurality of support racks with containers to be dispensed.

29. A machine for dispensing a plurality of containers as defined in claim 28 each of said support racks include a plurality of parallel channels therein for supporting and guiding the plurality of containers supported by the support racks.

30. A machine for dispensing a plurality of containers as defined in claim 28 wherein each of said support racks is inclined from a horizontal position in a downwardly direction toward the front of said vending rack to enable containers located in said channels and supported by said support rack to move under the influence of gravity towards the front of the vending rack.

31. A machine for vending a plurality of containers as is defined in claim 28 wherein said support for supporting said vending rack for rotation about a vertical axis includes a bearing assembly operatively associated with the bottom of the vending rack and the storage cabinet for supporting said vending rack in said storage cabinet for rotation relative to said storage cabinet about said vertical axis.

32. A machine for vending a plurality of containers as is defined in claim 31 wherein said support for supporting said vending rack for rotation about a vertical axis further includes a coupling operatively associated with the top of said vending rack and an alignment axle disposed on the top of the storage cabinet and received in said coupling to support the top of said vending rack for rotation about said vertical axis and to support the top of said vending rack in vertical alignment with said bearing assembly.
